(19) United States
(12) Patent Application Publication
(10) Pub. No.: US 2022/0147923 A1
(43) Pub. Date: May 12, 2022

(54) INFORMATION PROCESSING DEVICE, INFORMATION PROCESSING METHOD, AND PROGRAM

(71) Applicant: Toyota Jidosha Kabushiki Kaisha, Toyota-shi Aichi-ken (JP)

(72) Inventors: Takaaki Yanagihashi, Toyota-shi (JP); Takahiro Okano, Chiryu-shi (JP); Toru Takashima, Susono-shi (JP); Hiroaki Kiyokami, Nisshin-shi (JP); Kenta Miyahara, Okazaki-shi (JP); Yohei Tanigawa, Toyota-shi (JP)

(73) Assignee: Toyota Jidosha Kabushiki Kaisha, Toyota-shi Aichi-ken (JP)

(21) Appl. No.: 17/399,388

(22) Filed: Aug. 11, 2021

(30) Foreign Application Priority Data
Nov. 6, 2020 (JP) 2020-185908

(51) Int. Cl. G06Q 10/08; G06Q 30/02; G06F 21/31

(52) U.S. Cl. CPC G06Q 10/0834; G06F 21/31; G06Q 30/0207

(57) ABSTRACT

An information processing device receives identification information for identifying a predetermined cargo handling operation which is performed at a base for loading or unloading cargo, identifies a user who is able to accept the cargo handling operation based on the identification information, and generates request information which is displayed to the identified user based on the identification information.

### CROSS-REFERENCE TO RELATED APPLICATION

This application claims priority to Japanese Patent Application No. 2020-185908 filed on Nov. 6, 2020, incorporated herein by reference in its entirety.

### BACKGROUND

### 1. Technical Field

The disclosure relates to an information processing device, an information processing method, and a program.

### 2. Description of Related Art

Japanese Unexamined Patent Application Publication No. 2006-260012 (JP 2006-260012 A) discloses a physical distribution management system that matches the units of distribution of recovered used products and regenerated resupplied products when used products which are generated in a market are recovered, regenerated, and reused. In such a physical distribution management system, an estimated frequency distribution including operability of recovered products for each recovery base (a warehouse) is generated. Then, warehousing/release of the recovered products in the recovery bases to a regeneration base (a factory) can be performed according to a throughput of regeneration in the regeneration base based on the estimated frequency distribution. As a result, optimization of physical distribution management associated with a quantity, quality, and warehousing/release timings of recovered products received at the regeneration base from the recovery bases can be achieved.

### SUMMARY

In physical distribution bases such as factories or warehouses, since loading or unloading of cargo is frequently performed, it can be expected that the physical distribution efficiency would be improved by achieving an increase in efficiency of cargo handling operations accompanying loading or unloading of cargo.

For example, a base in which transportation trucks and the like start and arrive and cargo handling for each vehicle is performed is provided in a site of a factory, a warehouse, or the like. In such a base, the number of vehicles that can simultaneously perform cargo handling operations is limited due to a problem in space or the like. Accordingly, a vehicle having arrived later has to be on standby.

In this situation, when a cargo handling operation which is being performed is interrupted due to a shortage of manpower on the vehicle side or the factory side, the cargo handling operation of a subsequent vehicle may be affected and thus there may be a knock-on delay in cargo handling operations. Accordingly, when support for efficiently securing manpower required for the cargo handling operation can be carried out, it is possible to achieve an increase in efficiency of cargo handling operations and to enhance physical distribution efficiency.

The disclosure provides an information processing device, an information processing method, and a program that can achieve an increase in efficiency of cargo handling operations at a base for loading or unloading cargo.

According to a first aspect of the disclosure, there is provided an information processing device including: a reception unit configured to receive identification information for identifying a predetermined cargo handling operation which is performed at a base for loading or unloading cargo; an identification unit configured to identify a user who is able to accept the cargo handling operation based on the identification information; and an information generating unit configured to generate request information which is displayed to the user identified by the identification unit based on the identification information.

The information processing device according to the first aspect receives identification information for identifying a predetermined cargo handling operation which is performed at a base for loading or unloading cargo and identifies a user who is able to accept the cargo handling operation. On the other hand, the information processing device generates request information which is displayed to the identified user based on the received identification information. Accordingly, for example, it is possible to perform support for efficiently securing personnel necessary for a predetermined cargo handling operation requiring support of the cargo handling operation. As a result, it is possible to achieve an increase in efficiency of cargo handling operations and to improve physical distribution efficiency.

An information processing device according to a second aspect of the disclosure has the configuration according to the first aspect, in which the user includes occupants of vehicles which are scheduled to perform a cargo handling operation at the base and which are waiting at a position before the base.

The information processing device according to the second aspect can request a cargo handling operation to, for example, an occupant of a vehicle which is waiting for a cargo handling operation before the base for loading or unloading cargo.

An information processing device according to a third aspect of the disclosure has the configuration according to the second aspect, in which the user is an occupant of a vehicle which has arrived at the base prior to a scheduled arrival time and which is waiting at the position out of the occupants.

The information processing device according to the third aspect can make a request for a cargo handling operation to, for example, an occupant of a vehicle which has arrived at the base prior to a scheduled arrival time out of vehicles which are waiting before the base for loading or unloading cargo. Accordingly, since a request for a cargo handling operation is not made to a particular occupant of a vehicle having arrived after a scheduled arrival time, such an occupant can be made to wait to perform a cargo handling operation for their own vehicle.

An information processing device according to a fourth aspect of the disclosure has the configuration according to any one of the first to third aspects, in which the user is a predetermined user who has a level indicating an evaluation value of that user associated with the cargo handling operation corresponding to details of the cargo handling operation.

The information processing device according to the fourth aspect can request the cargo handling operation to a user with a level corresponding to details of the cargo handling operation, for example, with reference to the levels indicating evaluation values of users associated with the cargo handling operation. Therefore, for example, in the case of a request when a degree of difficulty in operations such cargo handling using a forklift or cargo handling operations with precision equipment is high, it is possible to identify a user suitable for such conditions.

An information processing device according to a fifth aspect of the disclosure has the configuration according to the fourth aspect, further including an information storage unit and an information updating unit, in which the information storage unit is configured to store the level, and the information updating unit is configured to update the level based on a result of the cargo handling operation performed by the user.

With the information processing device according to the fifth aspect, since an evaluation level of a user is updated with the result of the cargo handling operation, for example, the levels of users who are highly experienced in the cargo handling operation can be enhanced by evaluation. Accordingly, a system can be revitalized by motivating users to participate in such a support system.

An information processing device according to a sixth aspect of the disclosure has the configuration according to any one of the first to fifth aspects, in which the information generating unit is configured to add an incentive to the cargo handling operation to the request information.

With the information processing device according to the sixth aspect, the request information includes an incentive to the cargo handling operation. Accordingly, a user can consider the incentive at the time of considering whether to accept the cargo handling operation.

An information processing device according to a seventh aspect of the disclosure has the configuration according to the sixth aspect, in which the identification information includes input information which is input by another user who requests the cargo handling operation, and the incentive is arbitrarily set when the other user inputs the input information.

With the information processing device according to the seventh aspect, an incentive to a cargo handling operation is arbitrarily set by another user who makes a request for the cargo handling operation. As a result, for example, the incentive can be set in consideration of the circumstances of a user requesting a cargo handling operation, such as setting a relatively large incentive for a simple operation which needs to be performed rapidly or when the incentives of other requesters are considered.

An information processing device according to an eighth aspect of the disclosure has the configuration according to the sixth aspect, wherein the incentive is an incentive which is set in advance based on details of the cargo handling operation.

With the information processing device according to the eighth aspect, since the incentive is set according to details of the cargo handling operation, it is possible to decrease the number of conditions which change for each request and to avoid problems associated with request details.

An information processing device according to a ninth aspect of the disclosure has the configuration according to any one of the first to eighth aspects, in which the information generating unit is configured to add contract information associated with the cargo handling operation to the request information.

With the information processing device according to the ninth aspect, contract information associated with the cargo handling operation is included in the request information. Accordingly, for example, a user who requests or accepts the cargo handling operation can request or accept the cargo handling operation after making a contract for the cargo handling operation or various damage insurance contracts in preparation for unexpected situations during the operation. As a result, a user can request and accept (contract) the cargo handling operation with an easy conscience.

According to a tenth aspect of the disclosure, there is provided an information processing method including: receiving identification information for identifying a predetermined cargo handling operation which is performed at a base for loading or unloading cargo; identifying a user who is able to accept the cargo handling operation based on the identification information; and generating request information which is displayed to the identified user based on the identification information.

With the information processing method according to the tenth aspect, as described above, it is possible to achieve an increase in efficiency of cargo handling operations at a base for loading or unloading cargo.

According to an eleventh aspect of the disclosure, there is provided a program causing a computer to perform: receiving identification information for identifying a predetermined cargo handling operation which is performed at a base for loading or unloading cargo; identifying a user who is able to accept the cargo handling operation based on the identification information; and generating request information which is displayed to the identified user based on the identification information.

With the program according to the eleventh aspect, as described above, it is possible to achieve an increase in efficiency of cargo handling operations at a base for loading or unloading cargo.

According to the disclosure, it is possible to achieve an increase in efficiency of cargo handling operations at a base for loading or unloading cargo.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating a configuration of a delivery system according to a first embodiment;

FIG. 2 is a block diagram illustrating a hardware configuration of an information processing device 20 according to the first embodiment;

FIG. 3 is a block diagram illustrating a hardware configuration of an information processing device 30 according to the first embodiment;

FIG. 4 is a block diagram illustrating functional configurations of the information processing device 20 and the information processing device 30;

FIG. 5 is a diagram illustrating an example of a table of a user information database according to the first embodiment;

FIG. 6 is a flowchart illustrating an example of a routine of a support process of supporting request and contract for a cargo handling operation;

FIG. 7A is a diagram illustrating an example of a display screen which is displayed in the information processing device 30;

FIG. 7B is a diagram illustrating an example of a display screen which is displayed in the information processing device 30;

FIG. 7C is a diagram illustrating an example of a display screen which is displayed in the information processing device 30;

FIG. 7D is a diagram illustrating an example of a display screen which is displayed in the information processing device 30;

FIG. 8A is a diagram illustrating an example of a display screen which is displayed in the information processing device 30;

FIG. 8B is a diagram illustrating an example of a display screen which is displayed in the information processing device 30;

FIG. 8C is a diagram illustrating an example of a display screen which is displayed in the information processing device 30;

FIG. 9A is a diagram illustrating an example of a display screen which is displayed in the information processing device 30;

FIG. 9B is a diagram illustrating an example of a display screen which is displayed in the information processing device 30; and

FIG. 10 is a block diagram illustrating a functional configuration of an information processing device 40 according to a second embodiment.

### DETAILED DESCRIPTION OF EMBODIMENTS

### First Embodiment

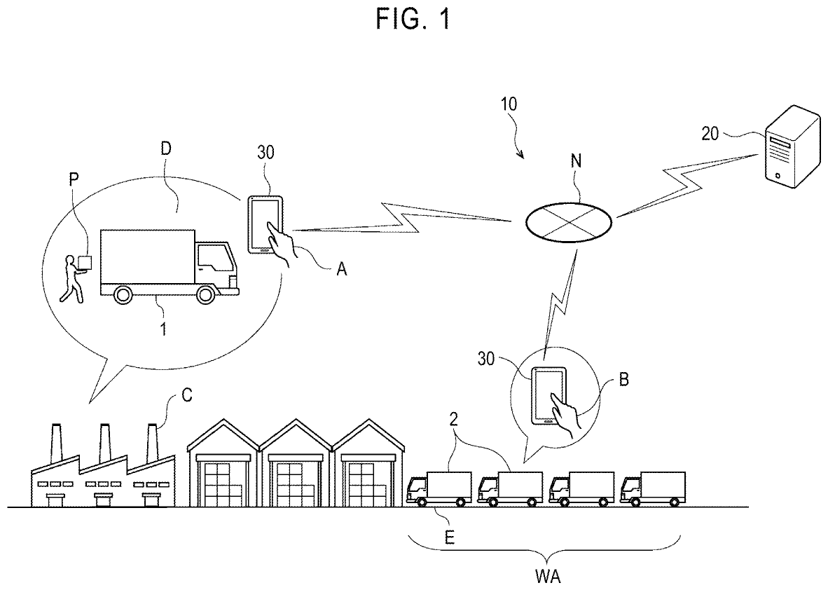

Hereinafter, a support system 10 according to an embodiment of the disclosure will be described with reference to the accompanying drawings. FIG. 1 is a diagram schematically illustrating a configuration of a support system 10 according to a first embodiment. The support system 10 includes an information processing device 20 and an information processing device 30. The information processing device 20 and the information processing device 30 are configured to communicate with each other via a network N. For example, the information processing device 20 operates as a server. The information processing device 30 is a terminal which is used by a user who uses the support system 10, for example, a smartphone or a personal computer.

The support system 10 provides a service for connecting a user A who wants to request a cargo handling operation to another user and a user B who can accept (contract) a cargo handling operation of another user in association with a cargo handling operation which is performed at a base for loading/unloading cargo P.

For example, a flow in which a user A who is scheduled to perform unloading work for a vehicle 1 of the user A in a factory C makes a request to another user B for a part of the cargo handling operation of the vehicle 1 to be performed using the support system 10 will be described below. In the site of the factory C illustrated in FIG. 1, a base D for loading or unloading cargo P is provided. It is assumed that the user A at the base D will start handling of the cargo P from the vehicle 1 soon, but wants to request support of the cargo handling operation because a start time of the cargo handling operation is delayed from the scheduled time. The user A requests the cargo handling operation for the vehicle 1 using the information processing device 30.

On the other hand, a waiting area WA of vehicles 2 waiting for loading or unloading cargo P is provided at a position E which is a position before the base D. A user B confirms the request from the user A using the information processing device 30 and permits acceptance of the cargo handling operation. Accordingly, the user B can move from the waiting area E to the base D and support the cargo handling operation for the vehicle 1.

The information processing device 20 and the information processing device 30 will be described below in detail.

### Hardware Configuration of Information Processing Device 20

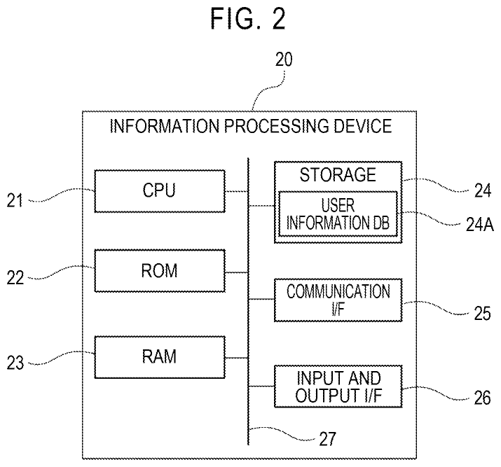

FIG. 2 is a block diagram illustrating a hardware configuration of the information processing device 20. The information processing device 20 includes a central processing unit (CPU) 21, a read only memory (ROM) 22, a random access memory (RAM) 23, a storage 24, a communication interface (I/F) 25, and an input and output interface 26. The CPU 21, the ROM 22, the RAM 23, the communication interface 25, and the input and output interface 26 are connected via a bus 27 such that they can communicate with each other.

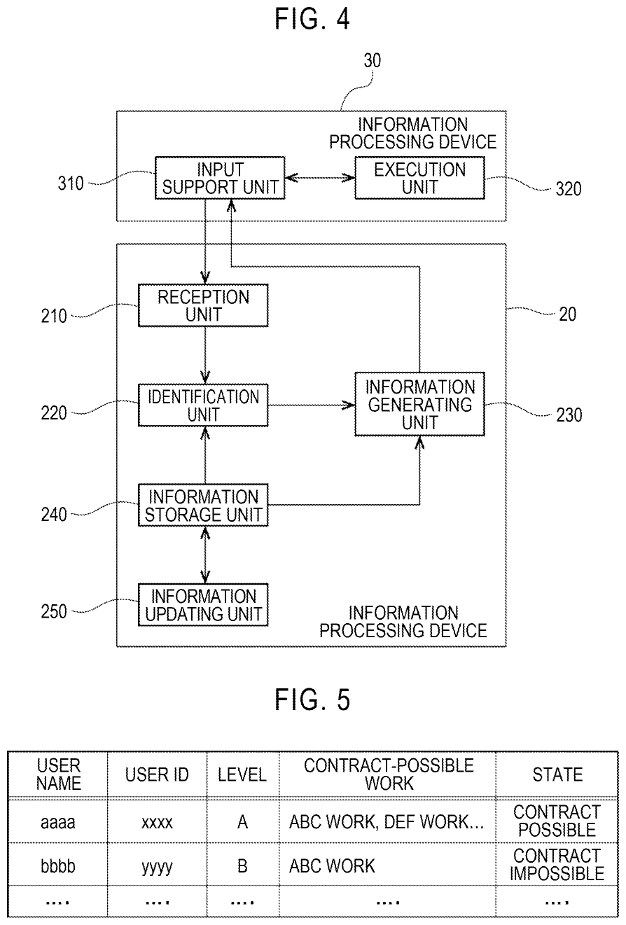

The CPU 21 is a central processing unit and executes various programs or controls constituent units. That is, the CPU 21 reads a program from the ROM 22 or the storage 24 and executes the program using the RAM 23 as a work area. In this embodiment, execution programs are stored in the ROM 22 or the storage 24. The CPU 21 realizes functions of a reception unit 210, an identification unit 220, an information generating unit 230, an information storage unit 240, and an information updating unit 250 which are illustrated in FIG. 4 by reading an execution program stored in the ROM 22 and executing the execution program.

The ROM 22 stores various programs and various types of data. The RAM 23 serves as a work area and temporarily stores a program or data. The storage 24 is constituted by a hard disk drive (HDD) or a solid state drive (SSD) and stores various programs including an operating system and various types of data. In this embodiment, a user information database (DB) 24A is stored in the storage 24. A storage unit such as the storage 24 can also be provided in another device that can communicate with the information processing device 20.

The communication interface 25 serving as a communication unit is an interface for communicating with the information processing device 30 or the like and, for example, a standard such as Ethernet (registered trademark), FDDI, or Wi-Fi (registered trademark) is used.

The input and output interface 26 is an interface for connecting an external device to the information processing device 20. The input and output interface 26 is a connection part based on a standard such as Universal Serial Bus (USB) or High-Definition Multimedia Interface (HDMI: registered trademark) and enables connection of an input device such as a keyboard or a display device such as a monitor.

A general-purpose computer for a server, a personal computer, or the like can be used as the information processing device 20 and the information processing device 20 may be constituted by a plurality of computers.

### Hardware Configuration of Information Processing Device 30

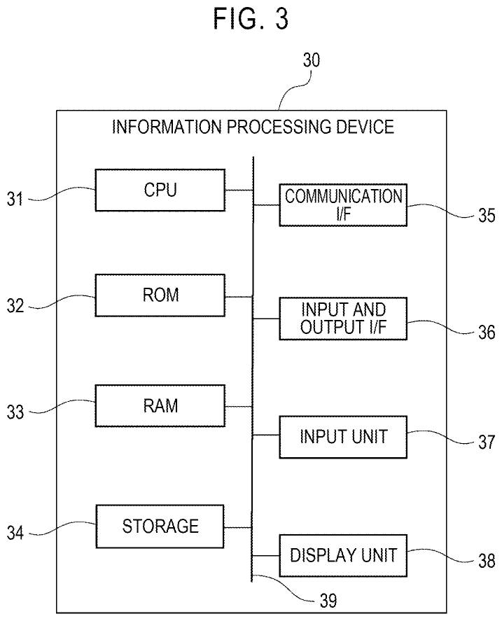

FIG. 3 is a block diagram illustrating a hardware configuration of the information processing device 30. The information processing device 30 includes a CPU 31, a ROM 32, a RAM 33, a storage 34, a communication interface 35, an input and output interface 36, an input unit 37, and a display unit 38. The CPU 31, the ROM 32, the RAM 33, the communication interface 35, the input and output interface 36, the input unit 37, and the display unit 38 are connected via a bus 39 such that they can communicate with each other.

The CPU 31 reads a program from the ROM 32 or the storage 34 and executes the program using the RAM 33 as a work area. In this embodiment, execution programs are stored in the ROM 32. The CPU 31 realizes functions of an input support unit 310 and an execution unit 320 which are illustrated in FIG. 4 by reading an execution program stored in the ROM 32 and executing the read execution program.

The ROM 32 stores various programs and various types of data. The RAM 33 serves as a work area and temporarily stores a program or data. The storage 34 serving as a storage unit is constituted by an HDD or an SSD and stores various programs and various types of data.

The communication interface 35 serving as a communication unit is an interface for communicating with an external device such as the information processing device 20 or another information processing device 30 and, for example, a standard such as Ethernet (registered trademark), FDDI, or Wi-Fi (registered trademark) is used.

The input and output interface 36 is an interface for connecting an external device to the information processing device 30. The input and output interface 36 is a connection part based on a standard such as USB or an HDMI and enables connection of an input device such as a keyboard or a display device such as a monitor.

The input unit 37 receives an operation input. The display unit 38 displays information or the like on a screen thereof. The input unit 37 and the display unit 38 may be integrated into a touch panel.

### Functional Configurations of Information Processing Device 20 and Information Processing Device 30

FIG. 4 is a block diagram illustrating the functional configurations of the information processing device 20 and the information processing device 30. The functions of the information processing device 20 and the information processing device 30 will be described below with reference to the drawing. The information processing device 20 includes a reception unit 210, an identification unit 220, an information generating unit 230, an information storage unit 240, and an information updating unit 250. The information processing device 30 includes an input support unit 310 and an execution unit 320.

The reception unit 210 is configured to receive identification information for identifying a predetermined cargo handling operation which is performed at a base for loading or unloading cargo. The identification information is input from the input support unit 310. The input support unit 310 is, for example, a software keyboard and inputs input information such as characters or character strings input from users (A, B, . . . ) as identification information to the reception unit 210. The input support unit 310 inputs an operation which is performed on various instruction objects displayed on the display unit 38 of the information processing device 30 by a user as the identification information to the reception unit 210. An input destination of the identification information input by the input support unit 310 is the execution unit 320 and the function of the execution unit 320 is realized by application software which is executed by the information processing device 30. The function of the execution unit 320 is, for example, a function for requesting or contracting a cargo handling operation.

The identification unit 220 is configured to identify a user who can accept a cargo handling operation based on the identification information received by the reception unit 210. At this time, the identification unit 220 identifies a user who can accept a cargo handling operation from stored (registered) user information with reference to information of a user information database 24A stored in the storage 24.

An example of a data table of the user information database 24A is illustrated in FIG. 5. As illustrated in the drawing, user information may include names of registered users, user IDs for identifying the users in an application, levels indicating evaluation values of the users associated with a cargo handling operation, a type of the cargo handling operation which can be contracted by the users, and information on whether the users can contract a cargo handling operation at a current time point. In addition, the user information may include work histories of the past performance of users or information on evaluation points which were given from requestors at the time of work in the past.

The levels of the users may be set, for example, based on types of cargo handling operations which can be contracted by the users or may be set based on results of the cargo handling operations which were performed by the users. The results of the cargo handling operations of the users may be calculated in consideration of work histories of the past performance of users or information on evaluation points which were given from requestors at the time of work in the past.

Various methods are conceivable for setting whether a user can contract a cargo handling operation at the current time point. For example, this may be set depending on whether a user starts application software for requesting or contracting a cargo handling operation. That is, a “contract-possible” state in which a user can contract a cargo handling operation may be set for a user who has started the application software, and a “contract-impossible” state in which a user cannot contract a cargo handling operation may be set for a user who is not starting the application software. Alternatively, it may be set depending on whether a user is located at a position before a base for loading or unloading cargo (for example, a point E before a base C). That is, a user who is located at the position E may be set to be in a “contract-possible” state and a user who is not located at the position E may be set to the “contract-impossible” state. When it is set depending on whether a user is located at a position before the base for loading or unloading cargo, a user who is located at the position E may be set to the “contract-possible” state when a vehicle 2 with the user as an occupant (that is, a vehicle which is scheduled to perform a cargo handling operation at the base C) is a vehicle which has arrived at the base prior to a scheduled arrival time and which is waiting at the position E, and a user in a vehicle having arrived after a scheduled arrival time may be set to the “contract-impossible” state even when the vehicle is located at the position E. Regarding scheduled times of vehicles, for example, a scheduled arrival time of a vehicle in which a user rides may be referred to from a vehicle database (not illustrated) in which a scheduled arrival time and a scheduled departure time are stored in correlation for each vehicle arriving at the base C.

The information generating unit 230 generates request information on a request for a cargo handling operation based on the received identification information. The request information is displayed to a user identified by the identification unit 220. The request information may include details of the cargo handling operation, information of a user who has requested the cargo handling operation, an incentive to the cargo handling operation, and contract information associated with the cargo handling operation. The details of the cargo handling operation may include a date and time at which the cargo handling operation is to be started, a place at which the cargo handling operation is to be performed, a time for the scheduled operation from start to end of the cargo handling operation, and information on the type of the cargo handling operation. The incentive to the cargo handling operation may be an amount of money which is paid to a contractor of the cargo handling operation or may be points which can be distributed in application software for requesting or contracting the cargo handling operation. The contract information associated with the cargo handling operation may be information associated with a contract which is made between a requester (an orderer) who makes a request for the cargo handling operation and a contractor who makes a contract for the cargo handling operation or information associated with insurance contracts for various damage insurances.

In addition, information which is generated by the information generating unit 230 may include a start instruction object for starting application software for requesting or contracting a cargo handling operation, a request instruction object for instructing to request a predetermined cargo handling operation, or a contract instruction object for instructing to subcontract a cargo handling operation. When the start instruction object is included in the information, information on the levels of users stored in the user information database 24A may be displayed at the time of display of a start screen. When the corresponding application software is not installed in the information processing device 30, the corresponding application software may be installed or a web browser may be started using an address of a corresponding web site as an argument.

The information storage unit 240 stores user information in the user information database 24A. For example, the information storage unit 240 stores the levels of the users. The information storage unit 240 stores various types of acquired data in the storage 24.

The information updating unit 250 acquires information associated with user information from a user's input operation information and updates the user information stored in the user information database 24A. For example, the information updating unit 250 updates the levels of the users based on results of cargo handling operations of users. In addition, the information updating unit 250 updates various types of acquired data stored in the storage 24.

### Operation

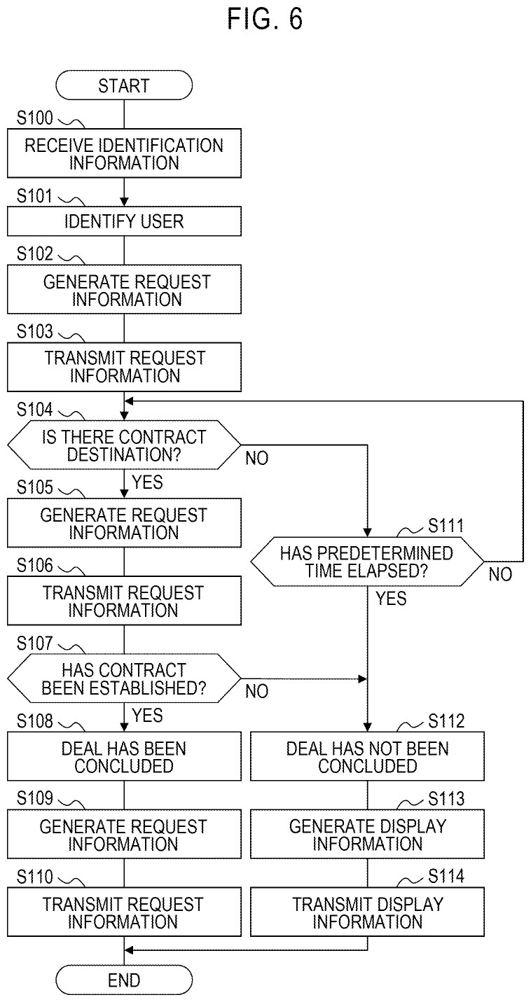

The operation of the information processing device 20 will be described below with reference to FIG. 6. FIG. 6 is a flowchart illustrating an example of a routine of a support process which is performed when requesting and contracting of a cargo handling operation between users are relayed by the information processing device 20. This support process enables relaying of a contract for a cargo handling operation which is made between users.

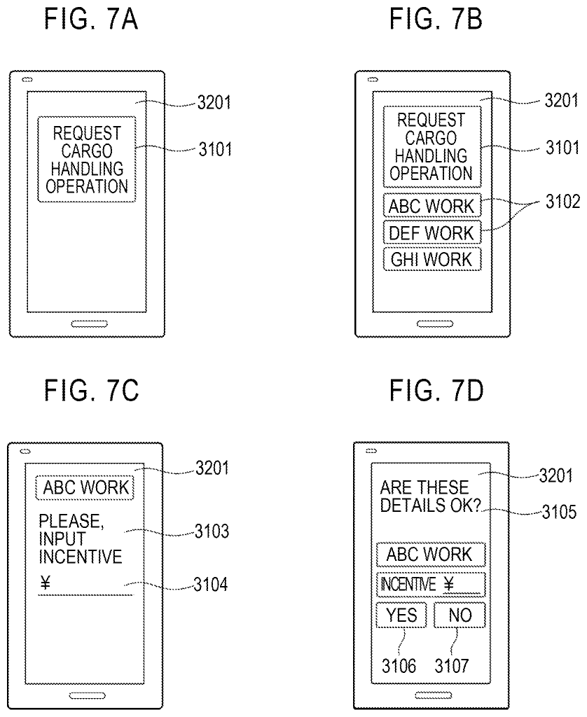

First, it is assumed that a user who operates the information processing device 30 starts application software for requesting or contracting a cargo handling operation such that an application screen 3201 is displayed on the information processing device 30 (see FIG. 7A). It is assumed that a setting instruction button 3101 which is a setting instruction object for instructing to set requesting of a cargo handling operation is displayed on the application screen 3201. When the user selects the setting instruction button 3101, the reception unit 210 is notified of start information indicating that setting of request information has been started. The application screen 3201 corresponds to the execution unit 320 and the setting instruction button 3101 corresponds to the input support unit 310.

When the user selects the setting instruction button 3101, the information generating unit 230 displays character strings indicating candidates for the type of the requested cargo handling operation (see FIG. 7B). These character strings constitute type setting instruction buttons 3102 of which each is a type setting instruction object for instructing to set a type of the cargo handling operation. The type of the cargo handling operation may be set in response to the user's input to a text box displayed on the application screen 3201.

Subsequently, as illustrated in the example of FIG. 7C, the set type of the cargo handling operation, a message 3103 for requesting setting of an incentive to the cargo handling operation, and a text box 3104 for inputting an amount of money as the incentive are displayed on the application screen 3201. When an amount of money is input and set by the user, a message 3105 for requesting confirmation of details of the set cargo handling operation is displayed (FIG. 7D). Information on the set type and incentive of the cargo handling operation is displayed below the message 3105. A request instruction button 3106 which is a request instruction object for instructing to request a cargo handling operation and a stop instruction button 3107 which is a stop instruction object for instructing to stop the request for the cargo handling operation are displayed on the application screen 3201.

The incentive to a cargo handling operation is not limited to a case in which it is arbitrarily set by a user as described above and may be an incentive which is set in advance according to details of the cargo handling operation. For example, a table for determining incentives to details of cargo handling operations may be stored in the storage 24 and the incentive to a predetermined cargo handling operation may be set with reference to the incentive table.

Subsequently, when the user selects the request instruction button 3106, identification information for identifying a cargo handling operation is generated and is transmitted to the reception unit 210.

Then, when the reception unit 210 receives the identification information, the support process illustrated in FIG. 6 is performed.

In Step S100 in FIG. 6, the CPU 21 of the information processing device 20 receives the identification information. When the identification information is received, the routine proceeds to Step S101.

In Step S101, the CPU 21 identifies a user who can accept (contract) the cargo handling operation with reference to the user information database 24A. Specifically, the CPU 21 may identify a user whose user state in the user information database 24A is the “contract-possible” state as the user who can accept the cargo handling operation. Alternatively, the CPU 21 may identify a user whose level corresponds to the type of the cargo handling operation out of users in the “contract-possible” state. When the CPU 21 identifies a user, the CPU 21 causes the routine to proceed to Step S102.

In Step S102, the CPU 21 generates request information on the request for the cargo handling operation based on the received identification information. When the request information is generated, the CPU 21 causes the routine to proceed to Step S103.

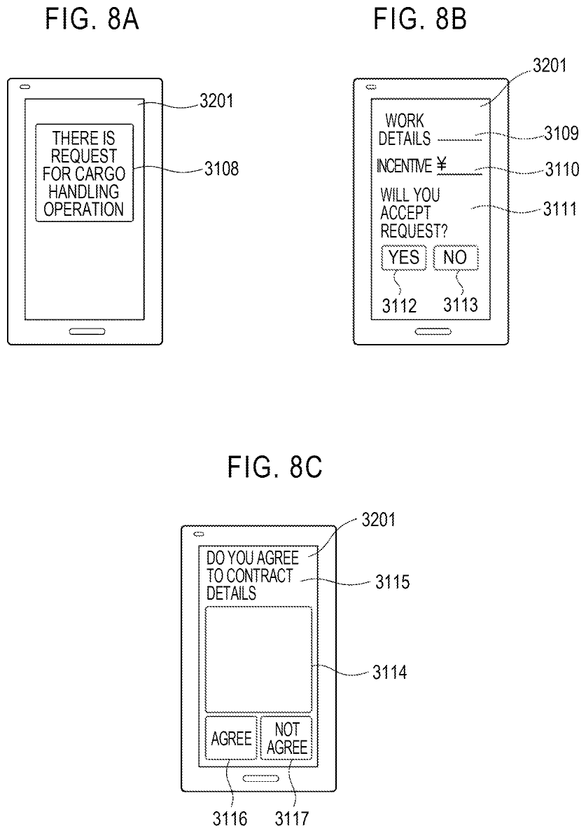

In Step S103, the CPU 21 transmits the request information to a predetermined user who is identified as the user who can accept the cargo handling operation. An example of the application screen 3201 of the information processing device 30 of the identified user is illustrated in FIG. 8A. As illustrated in the drawing, when the request information is transmitted, a message for notifying the request for the cargo handling operation is displayed on the application screen 3201. The message constitutes a confirmation instruction button 3108 which is a confirmation instruction object for instructing confirmation of the request information.

When the user selects the confirmation instruction button 3108, the reception unit 210 is notified of confirmation requirement information for requiring confirmation of the request information. Then, the request information is displayed on the application screen 3201. The request information includes information 3109 associated with the details of the cargo handling operation and information 3110 associated with an incentive (see FIG. 8B). Then, below the request information, a message 3111 for confirming whether the user can accept the cargo handling operation, a contract instruction button 3112 which is a contract instruction object for instructing contracting of the cargo handling operation, and a refusal instruction button 3113 which is a refusal instruction object for instructing to refuse the contracting of the cargo handling operation are displayed. When the user selects the contract instruction button 3112, the reception unit 210 is notified of contract information indicating that unloading work is accepted.

In Step S104, the CPU 21 determines whether there is a contract destination which accepts the cargo handling operation. Specifically, the CPU 21 determines that there is a contract destination when contract information is received from the user who has transmitted the request information. On the other hand, the CPU 21 determines that there is no contract destination when the contract information has not been accepted. The CPU 21 causes the routine to proceed to Step S105 when it is determined that there is a contract destination. On the other hand, the routine proceeds to Step S111 when it is determined that there is no contract destination.

In Step S105, when the contract information is received by the reception unit 210, the CPU 21 generates request information which is displayed to the user who has sent the request information. When the request information is generated by the CPU 21, the CPU 21 causes the routine to proceed to Step S106.

In Step S106, the CPU 21 transmits the request information to the user who has notified of the contract information. The request information includes contract information associated with the cargo handling operation. When the request information is transmitted, the CPU 21 causes the routine to proceed to Step S107.

An example of the request information is illustrated in FIG. 8C. As illustrated in the drawing, a message 3115 for requiring confirmation of whether the user agrees to contract details in addition to contract information 3114 associated with the cargo handling operation is displayed on the application screen 3201. In addition, a contract agreement instruction button 3116 which is a contract agreement instruction object for instructing to agree to the contract details and a contract refusal instruction button 3117 which is a contract refusal instruction object for instructing to refuse agreement to the contract details are displayed. When the user selects the contract agreement instruction button 3116, the reception unit 210 is notified of contract permission information indicating that the cargo handling operation is accepted. On the other hand, when the user selects the contract refusal instruction button 3117, the reception unit 210 is notified of contract cancel information indicating that acceptance of the cargo handling operation is cancelled out.

In Step S107, the CPU 21 determines whether a contract has been established. Specifically, when the reception unit 210 receives the contract permission information, the CPU 21 determines that the contract has been established. On the other hand, when the reception unit 210 receives the contract cancel information, the CPU 21 determines that the contract has not been established. When it is determined that the contract has been established, the CPU 21 causes the routine to proceed to Step S108. On the other hand, when it is determined that the contract has not been established, the CPU 21 causes the routine to proceed to Step S112.

In Step S108, the CPU 21 determines that a deal has been concluded between the user who makes a request for the cargo handling operation and the user who wants to accept the cargo handling operation and causes the routine to proceed to Step S109.

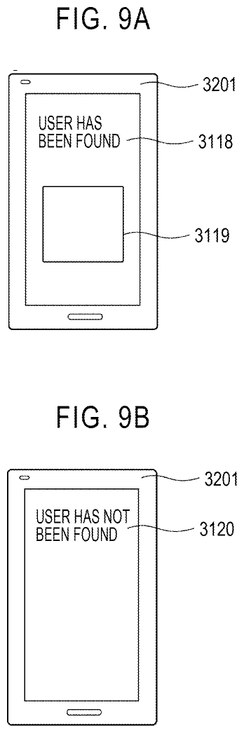

In Step S109, the CPU 21 generates request information which is displayed to the user who has requested the cargo handling operation, transmits the request information in Step S110, and then ends the routine. An example of display information which is displayed to the user who has requested the cargo handling operation is illustrated in FIG. 9A. As illustrated in the drawing, a message 3118 indicating that a user who accepts the cargo handling operation has been found and information 3119 of the user who is a contract destination are displayed on the application screen 3201.

On the other hand, a routine when a user who is a contract destination has not been found will be described below.

When it is determined in Step S104 that there is no contract destination and the routine proceeds to Step S111, the CPU 21 determines whether a predetermined time has elapsed after the request information has been transmitted to the user identified by the identification unit 220. When it is determined that the predetermined time has not elapsed, the CPU 21 repeatedly performs the process of Step S104. On the other hand, when it is determined that the predetermined time has elapsed, the CPU 21 causes the routine to Step S112.

In Step S112, the CPU 21 determines that a deal of the user who has requested the cargo handling operation has not been concluded and causes the routine to proceed to Step S113. In Step S113, the CPU 21 generates display information which is displayed to the user who has requested the cargo handling operation, transmits the display information in Step S114, and ends the routine. An example of the display information which is displayed to the user who has requested the cargo handling operation is illustrated in FIG. 9B. As illustrated in the drawing, a message 3120 indicating that a user who accepts the cargo handling operation has not been found is displayed on the application screen 3201.

As described above, the information processing device 20 of the support system 10 according to the first embodiment receives identification information for identifying a predetermined cargo handling operation which is performed at a base for loading or unloading cargo P and identifies a user B who is able to accept the cargo handling operation. The information processing device 20 generates request information which is displayed to the identified user B based on the received identification information. Accordingly, since a user A can efficiently secure necessary personnel when the cargo handling operation needs to be supported, it is possible to achieve an increase in efficiency of cargo handling operation and to contribute to improvement in physical distribution efficiency.

With the information processing device 20, an occupant of a vehicle 2 which is scheduled to perform a cargo handling operation at the base D and which is waiting at a position E before the base D can be identified as the user who is able to accept unloading. Accordingly, it is possible to request a cargo handling operation to an occupant of a vehicle which is waiting for a cargo handling operation.

The information processing device 20 can request the cargo handling operation to an occupant of a vehicle which has arrived at the base prior to a scheduled arrival time out of occupants of vehicles 2 which are waiting at the base E. Accordingly, since a request for a cargo handling operation is not made to a particular occupant of a vehicle having arrived after a scheduled arrival time, the occupant can be made to wait to perform a cargo handling operation for the occupant's vehicle.

The information processing device 20 can request the cargo handling operation to a user with a level corresponding to details of the cargo handling operation with reference to the levels indicating evaluation values of users associated with the cargo handling operation. Therefore, for example, in the case of a request when a degree of difficulty in operations such cargo handling using a forklift or cargo handling operations with precision equipment is high, it is possible to identify a user suitable for such conditions.

With the information processing device 20, an evaluation level of a user can be updated with the result of the cargo handling operation. For example, the levels of users who are highly experienced in the cargo handling operation can be enhanced by evaluation. Accordingly, a system can be revitalized by motivating users to participate in such a support system 10.

With the information processing device 20, the request information can include an incentive to the cargo handling operation. Accordingly, a user can consider the incentive at the time of considering whether to accept the cargo handling operation.

With the information processing device 20, an incentive to a cargo handling operation can be arbitrarily set by another user who makes a request for the cargo handling operation. In this case, for example, the incentive can be set in consideration of the circumstances of a user requesting a cargo handling operation, such as setting a relatively large incentive for a simple operation which needs to be performed rapidly or when the incentives of other requesters are considered.

With the information processing device 20, the incentive can be set according to details of the cargo handling operation. In this case, it is possible to decrease the number of conditions which change for each request and to avoid problems associated with request details.

With the information processing device 20, contract information associated with the cargo handling operation can be included in the request information. Accordingly, for example, a user who requests or accepts a cargo handling operation can request or accept the cargo handling operation after making a contract for the cargo handling operation or various damage insurance contracts in preparation for unexpected situations during work. As a result, a user can request and accept (contract) the cargo handling operation with an easy conscience.

### Second Embodiment

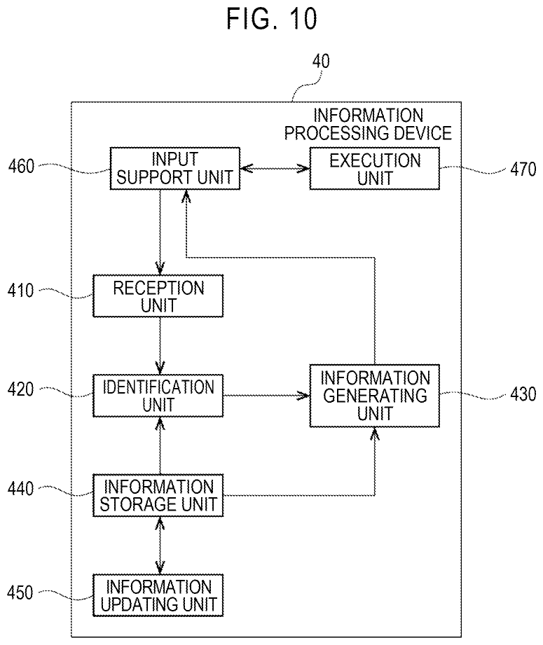

A second embodiment of the disclosure will be described below with reference to FIG. 10. The same elements as in the first embodiment will be referred to by the same reference signs and description thereof will not be repeated. In the second embodiment, the processes which are performed by the information processing device 20 and the information processing device 30 in the first embodiment are performed by an information processing device 40. The hardware configuration of the information processing device 40 is the same as the configuration of the information processing device 30 in the first embodiment and thus description thereof will be omitted.

FIG. 10 is a block diagram illustrating a functional configuration of the information processing device 40. The functions of the information processing device 40 are realized by causing the CPU 31 to read and execute an execution program stored in the ROM 32. As illustrated in FIG. 10, the information processing device 40 includes a reception unit 410, an identification unit 420, an information generating unit 430, an information storage unit 440, an information updating unit 450, an input support unit 460, and an execution unit 470.

The reception unit 410, the identification unit 420, the information generating unit 430, the information storage unit 440, the information updating unit 450, the input support unit 460, and the execution unit 470 correspond to the reception unit 210, the identification unit 220, the information generating unit 230, the information storage unit 240, the information updating unit 250, the input support unit 310, and the execution unit 320 in the first embodiment. The operations of the constituents of the information processing device 40 are the same as the operations of the information processing device 20 and the information processing device 30 in the first embodiment and thus detailed description thereof will not be repeated.

### REMARKS

Various processes which are performed by causing the CPUs 21 and 31 to read software (a program) in the aforementioned embodiments may be performed by various processors other than the CPU. Examples of the processors in this case include a programmable logic device (PLD) of which a circuit configuration can be changed after it has been manufactured such as a field-programmable gate array (FPGA) and a dedicated electric circuit which is a processor having a circuit configuration dedicatedly designed for perform specific processes such as an application-specific integrated circuit (ASIC). Various processes such as the support process may be performed by one of such processors or may be performed in combination of two or more processors of the same type or different types (for example, a plurality of FPGAs and a combination of a CPU and an FPGA). More specifically, the hardware structure of such processors is an electrical circuit in which circuit elements such as semiconductor elements are combined.

In the aforementioned embodiments, a program for the support process is stored (installed) in advance in the ROM or the storage, but the disclosure is not limited thereto. The program may be provided in a state in which it is recorded on a storage medium such as a compact disk read only memory (CD-ROM), a digital versatile disk read only memory (DVD-ROM), and a universal serial bus (USB) memory. The program may be downloaded from an external device via a network.

The flow of processes described above in the embodiment is only an example and an unnecessary step may be deleted, a new step may be added, or the order of performing the steps may be changed without departing from the gist of the disclosure.

What is claimed is:

1. An information processing device comprising:
a reception unit configured to receive identification information for identifying a predetermined cargo handling operation which is performed at a base for loading or unloading cargo;
an identification unit configured to identify a user who is able to accept the cargo handling operation based on the identification information; and
an information generating unit configured to generate request information which is displayed to the user identified by the identification unit based on the identification information.

2. The information processing device according to claim 1, wherein the user includes occupants of vehicles which are scheduled to perform a cargo handling operation at the base and which are waiting at a position before the base.

3. The information processing device according to claim 2, wherein the user is an occupant of a vehicle which has arrived at the base prior to a scheduled arrival time and which is waiting at the position out of the occupants.

4. The information processing device according to claim 1, wherein the user is a predetermined user whose a level indicating an evaluation value of the user associated with the cargo handling operation corresponds to details of the cargo handling operation.

5. The information processing device according to claim 4, further comprising an information storage unit and an information updating unit,
wherein the information storage unit is configured to store the level, and
wherein the information updating unit is configured to update the level based on a result of the cargo handling operation performed by the user.

6. The information processing device according to claim 1, wherein the information generating unit is configured to add an incentive to the cargo handling operation to the request information.

7. The information processing device according to claim 6, wherein the identification information includes input information which is input by another user who requests the cargo handling operation, and
wherein the incentive is arbitrarily set when the other user inputs the input information.

8. The information processing device according to claim 6, wherein the incentive is an incentive which is set in advance based on details of the cargo handling operation.

9. The information processing device according to claim 1, wherein the information generating unit is configured to add contract information associated with the cargo handling operation to the request information.

10. An information processing method comprising:
receiving identification information for identifying a predetermined cargo handling operation which is performed at a base for loading or unloading cargo;
identifying a user who is able to accept the cargo handling operation based on the identification information; and
generating request information which is displayed to the identified user based on the identification information.

11. A program causing a computer to perform:
receiving identification information for identifying a predetermined cargo handling operation which is performed at a base for loading or unloading cargo;
identifying a user who is able to accept the cargo handling operation based on the identification information; and
generating request information which is displayed to the identified user based on the identification information.
